(19) United States
(12) Patent Application Publication
(10) Pub. No.: US 2012/0151366 A1
(43) Pub. Date: Jun. 14, 2012

(54) Object sharing and scoring system

(76) Inventor: Chen-Yu Sheu, Irvine, CA (US)

(21) Appl. No.: 12/928,443

(22) Filed: Dec. 13, 2010

(51) Int. Cl. G06F 3/048

(52) U.S. Cl. 715/738

(57) ABSTRACT

This invention is related to an Object Sharing and Scoring System (OSSS) that allows users to build, create and trade values of objects in a multi-user computing environment. It considers user, space and document as three basic and interacting classes of objects, and allows users to create objects within a space, to specify the accessibility of an object in a space, etc., and it controls the access of an object by another object in a space. It also allows users to build, create value and manipulate objects based on a scoring system.

### BACKGROUND OF THE INVENTION

1. Field of the Invention

This invention is related to an Object Sharing and Scoring System (OSSS) that allows users to create, share and manipulate objects with a scoring system in a multi-user computing environment.

2. Description of the Related Art

While existing web publishing systems (e.g., traditional web publishing, blogs and social networking) have focused on users and content, this invention unifies them with the concept of “object” and provides a system with a new type of objects, namely “space”, in addition to “document” and “user”. The three types of objects interact with each other. A space is different from a simple folder or directory as it is an object that may contain other objects other than documents and spaces, i.e., members.

Specifically it allows users to create an object in a space, to specify the accessibility of an object by another object, to search objects, and to operate on an object in the space based on a scoring system.

In this invention the term “user” refers to a registered user unless otherwise specified.

### SUMMARY OF THE INVENTION

For purposes of summarizing the invention, certain aspects, advantages and novel features of the invention have been described herein. It should be understood that not necessarily all such aspects, advantages or features will be embodied in any particular embodiment of the invention.

The following subsections describe an object sharing and scoring system that embodies various inventive features. The various inventive features can be implemented differently than described herein. Thus, the following description is intended only to illustrate, and not limit, the scope of the present invention.

### Architecture of OSSS

The Object Sharing and Scoring System (OSSS) considers user, space and document as three basic and interacting classes of objects in a multi-user environment. It allows a user to create an object (document, space or member which is a user) within a space, specify its accessibility to other objects, to search objects, and to operate on an object in the space based on a scoring system.

The architecture of the OSSS system is shown in FIG. 1:
1. Space Navigation Interface 110, an interface through which a registered or un-registered user can navigate the spaces.
2. Object Definition Module 120, through which a user can create an object in a space, specify its accessibility to other objects, and define its value. It also allows a user to modify the definition of an object.
3. Object Management Module 130, through which a user can access and/or manipulate an object in a space.
4. Access Control Module 140, through which the Object Management Module decides if an object can be accessed by another object in a space.
5. Scoring Module 150, through which Object Management Module determines the (point) value of an operation on an object.
6. Database 160 that stores all objects and user accounts.

In OSSS a (point) score is associated with each account, where the score is initialized to a certain value when the account is created. A space can include documents, other spaces and members (users). The spaces can be structured as a space hierarchy, which means a space can be created within a space. The root(s) of the space hierarchy is determined by the system administrator. Each space is identified by ,a sequence of spaces in the space hierarchy that connects a/the root to the space called an (absolute) path name of the space. The sequence of spaces may be separated by slashes (i.e., space-name/space-name/space-name/ . . . ) or some other symbols depending on the implementation.

An object created in a space is accessed by the (absolute or relative) pathname followed by the name of the object. Each user account in OSSS can be a space.

A user, once logged in, can navigate to any space in the space hierarchy, and use a relative path name (i.e., a sequence of spaces in the space hierarchy that connects the current space and the target space) to access a space.

In one embodiment of OSSS, for example, if user abc created a space g1 and created a space g13 within g1, the absolute path name for g1 is abc/g1, and the absolute path name for g13 is abc/g1/g13. After the user abc logs in, the user can use the relative space name g1/g13 to reference the space g13.

In another embodiment of OSSS each user account is a space of a root space called “users.” If user abc created a space g1 within his/her account and created a space g13 within g1, the absolute path name for g1 is users/abc/g1, and the absolute path name for g13 is users/abc/g1/g13.

The Object Definition Module can be accessed by a user to create an object or modify its definition within a space. The possible definitions include, but are not limited to, the following:
Name of the object;
Accessibility of the object in the space by other users;
(Point) value of the object;
(Point) value of an operation (including read, write, execute) on the object.

The Scoring Module accesses the definition of an object to determine its value or the value of an operation on the object. The Access Control Module determines the access right of a user on the object.

The Object Management Module, working with the Access Control Module and the Scoring Module, can be accessed by a user to perform various operations on an object within a space. The possible operations include, but are not limited to, the following:
Delete the object (by the owner);
Read (browse) the object (by the owner or another authorized user);
Modify (write) the object (by the owner or another authorized user);
Sell the object (by the owner to another user);
Buy an object (by another user from its owner);
Grant an access right of an object (by the owner) to another user;
Propose a value (by another user to the owner) for an access right of the object.

A user may be allowed to propose a value to an object owned by another user and to propose a value to an access right of an object owned by the user. In this case the final value of an object or an access right is determined by the owner and the buyer based on negotiations.

One embodiment of the Object Management User Interface is shown in FIG. 2. At a block 210 it prompts the user to specify the name of the space under which the object (i.e., a space, document or user) is located. At a block 220 it prompts the user to specify the object to be operated. At a block 230 it prompts the user to specify an operation to be performed on the object. At a block 240 it checks if the user is allowed to perform the operation on the object within the space based on the accessibility of the object and, if so, at a block 250 it determines the (point) value of the operation. At a block 260 it determines if the user has enough points in her/his account to cover any loss of points corresponding to the operation. If not an error message is issued. Otherwise at a block 270 it adjusts the user's score based on the cost (profit) of the operation and at a block 280 it performs the operation.

One embodiment of space accessibility is defined by a combination of one or more access rights: (rp) read by other users, (wp) write by other users, (rwp) both read and write by other users, (ru) read by the user only, (wu) write by the user only, (rwu) both read and write by the user only, (rf) read by the members of the space only, (wf) write by the members of the space only, (rwf) both read and written by the members of the space only, etc.

One embodiment of document accessibility is defined as a combination of one or more access rights: (drp) read by other users, (dwp) write by other users, (drwp) both read and write by other users, (dru) read by the user only, (dwu) write by the user only, (drwu) both read and write by the user only, (drf) read by the members of the space only, (dwf) write by the members of the space only, (drwf) both read and write by the members of the space only, etc.

The Object Management Module works with the Access Control Module to determine the accessibility of an object (the first object) by another user (the second object) within a space. The accessibility is determined by a function that considers the accessibility of the two objects and the relationships among the three objects (including the space).

Assuming the first object is a document, one embodiment of the function is:
1. If the space belongs to the user and the space is defined to be shared, the document can be accessed by all members of the space.
2. If the space belongs to the user and the space is defined to be public, the document can be accessed by all users.
3. If the space belongs to the user and the space is defined to be private, the document can be seen by the user only.
4. If the space belongs to another user, is defined to be shared and the user is a member of that space, the document can be seen by all members of that space.
5. If the space belongs to another user, is defined to be shared and the user is not a member of that space, the document can be seen by the user only.
6. If the space belongs to another user, is defined to be public and the user is a member of that space, the document can be seen by all users.
7. If the space belongs to another user, is defined to be public and the user is not a member of that space, the document can be seen by the user only.
8. If the space belongs to another user and is defined to be private, the document can be seen by the user only.
9. If the space is a public space, the document can be seen by all users.
10. A registered or unregistered user of OSSS can submit a query. The result of a query may contain an executable object that contains or connects to a program or service so when the object is accessed by an authorized object the corresponding program or service is executed.

The Scoring Module keeps track of the total (point) score of each user in the user's account, where a user may be awarded some points when the user signs up as a registered user. A user can earn points via different operations that may be performed on an object.

In one embodiment of OSSS a user earns points via one of the following operations:
(a) selling an object owned by the user to another user;
(b) granting an access right for an object owned by the user to another user;
(c) creating an object in an object owned by the user;

In another embodiment of OSSS points are deducted from a user via one of the following operations:
(a) buying an object from another user;
(b) accessing an object owned by another user.

When an operation is performed on an object, the number of points corresponding to the value of the operation is deduced from the user who performs the operation and added to the user who owns the object. It is possible that the value of an operation is negative. In this case (e.g., a promotion) the points are deducted from the owner of the object and added to the user who performs the operation.

### BRIEF DESCRIPTION OF THE DRAWINGS

FIG. 1 illustrates one embodiment of the OSSS system.

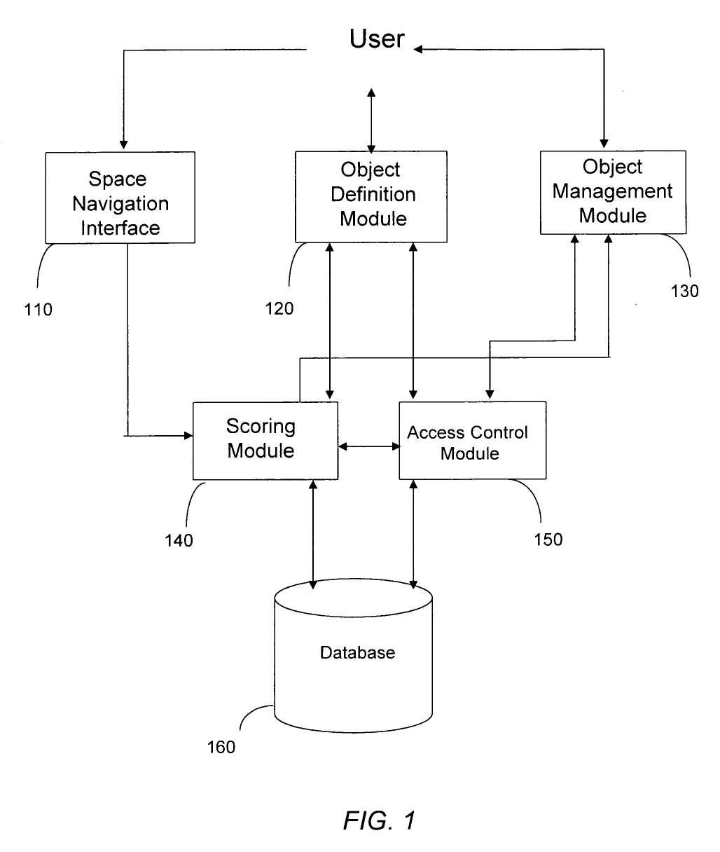

FIG. 2 illustrates one embodiment of the object management process in OSSS.

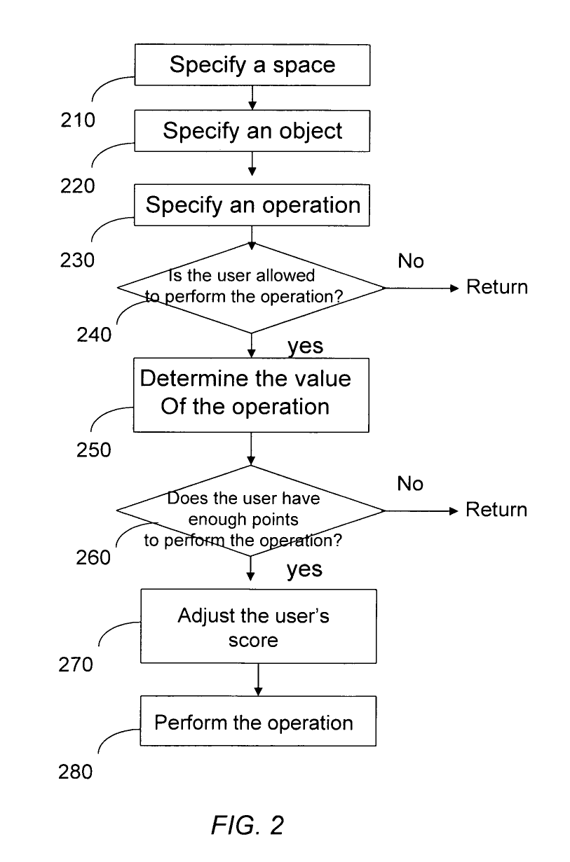

What is claimed is:

1. An object sharing and search system for a multi-user computing environment, the system comprising:
a computer interface that can be connected to a unregistered user that allows the user to create an account and become a user;
a computer interface that can be connected to a user that allows the user to navigate to a space;
a computer interface that can be connected to a user that allows the user to create, delete or access an object in a space;
a computer program that can decide if and how an object can be accessed by a user or another object in a space;
a database that stores the objects created;
a scoring program that keeps track of the points earned by each user.

2. A computer-implemented method of creating an object (document, space or user) by a user in a space, the method comprising:
Navigate the user to the space or prompt the user to enter the (absolute or relative) path name of the space in which the object is created;
Prompt the user to specify the type of the object to be created;
Check if the user is allowed to create an object of the specified type in the space specified; if not return with an error;
Prompt the user to specify the name of the new object;
Prompt the user to specify additional information for the new object:
Prompt the user to specify how the new object can be accessed based on its type (including read, write, search, browse, invite, execute, etc. or a combination of the above) by other objects (including the user, members of the space, members of another space, all users, general public including unregistered users, the space, another space, other documents in the space, documents in other spaces, etc.) in the space;
Prompt the user to assign a value to the object;
Prompt the user to assign a value to each access right on the object.

3. The method of claim 2, further comprising that one or more super-users are created by the system initially.

4. The method of claim 2, further comprising that a user can change the definition of an object or delete an object.

5. A computer-implemented method of managing the operations on an object (document, space or user) by a user in a space based on a scoring system, the method comprising:
Navigate the user to the object or prompt the user enter the (absolute or relative) path name of the object;
Prompt the user to specify (or choose) an operation to be performed on the object;
Check if the user is allowed to perform the operation on the object in the space specified; if not return with an error;
Determine the number of points earned or lost by the operation;
Determine if the score in the user's account is sufficient to cover the points lost from the operation (if any); if not return with an error;
Update the score of the user based on the points earned (lost) by the operation.
Perform the operation on the object.

6. The method of claim 5, further comprising that an executable object may contain or connect to a program or service that can be run when the object is accessed by an authorized user, and the program or service may generate one or more new objects.
